(19) United States
(12) Patent Application Publication
(10) Pub. No.: US 2004/0156340 A1
(43) Pub. Date: Aug. 12, 2004

(54) Method, system and packet data access node for prepaid quota provision

(75) Inventor: Lila Madour, Kirkland (CA)

Correspondence Address: ALEX NICOLAESCU, Ericsson Canada Inc., Patent Department (LMC/M/P), 8400 Decarie Blvd., Town Mount Royal, QC, H4P 2N2, CA

(73) Assignee: Telefonaktiebolaget L M Ericsson (pub1)

(21) Appl. No.: 10/668,336

(22) Filed: Sep. 24, 2003

Related U.S. Application Data
(60) Provisional application No. 60/445,809, filed on Feb. 10, 2003.

(51) Int. Cl. H04B 7/216

(52) U.S. Cl. 370/335; 370/342

(57) ABSTRACT

A method, Packet Data Access Node such as a CDMA2000 Packet Data Service Node (PDSN) and a packet data system for provisioning the PDAN with an interim prepaid quota for auxiliary service instances related to a connection with a prepaid subscriber. The prepaid terminal requests registration with the PDAN and a prepaid server returns to the PDAN an indication that the prepaid subscriber has subscribed to multiple service instances and to certain service options. Responsive thereto, the PDAN requests immediate pre-initialization of a prepaid quota for the auxiliary instances from the prepaid server, and installs the prepaid quota. When the prepaid subscriber requests the auxiliary instances during the connection with the PDAN, the prepaid quota is already installed in the PDAN, and data packets are properly routed. The PDAN may be a CDMA2000 Packet data Service Node (PDSN).

### PRIORITY STATEMENT UNDER 35 U.S.C.S.119(e) & 37 C.F.R.S.1.78

This non-provisional patent application claims priority based upon the prior U.S. provisional patent application entitled “PROPOSED CHANGES TO PREPAID BASELINE (V2.0)”, application No. 60/445,809, filed Feb. 10, 2003, in the name of Lila MADOUR.

### BACKGROUND OF THE INVENTION

1. Field of the Invention

The present invention relates to prepaid support for a mobile node of a telecommunications network.

2. Description of the Related Art

CDMA2000, also known as IMT-CDMA Multi-Carrier or IS-95, is a Code-Division Multiple Access (CDMA) version of the IMT-2000 standard developed by the International Telecommunication Union (ITU). The CDMA2000 standard is a third-generation (3G) mobile wireless technology allowing mobile nodes (e.g. mobile stations, wireless PDAs, etc) to access IP-based high-speed voice and data traffic over the CDMA-based cellular network. CDMA2000 can support mobile data communications at speeds ranging from 144 Kbps to 2 Mbps.

In order to fully recognize the advantages of the present invention, a short description of some technical concepts associated with CDMA 2000 IP-based cellular telecommunications networks is required. A typical CDMA2000 network comprises a number of nodes including a plurality of Mobile Nodes (MNs), a plurality of Base Stations (BSs), one or more Packet Control Functions (PCFS) and one or more Packet Data Serving Nodes (PDSNs), or their equivalent. The BSs may be connected to the PCF, which is an entity in the CDMA2000 Radio Access Network (RAN) that controls the transmission of data packets between the BSs and the PDSN. The PCF is in turn connected with the PDSNs.

In the CDMA 2000 network, the PDSN provides access to the Internet, intranets and applications servers for MNs utilizing the CDMA2000 RAN. Acting as an access gateway, the PDSN provides simple IP and mobile IP access, foreign agent support, and packet transport for virtual private networking. It may also act as a client for an Authorization, Authentication, and Accounting server (AAA) and provides the MNs with a gateway to the IP network.

When supporting the Mobile Internet Protocol, the CDMA2000 network further comprises a Home Agent (HA), which is a router on a MN's home network that maintains information about the MN's current location, as identified in its care-of-address. The HA uses tunnelling mechanisms to forward Internet traffic so that the MN's IP address does not have to be changed each time it connects from a different location. An HA may work in conjunction with a foreign agent, which is a router on the visited network. The foreign agent and the HA are two types of mobility agents, defined in the Internet Engineering Task Force IETF (Internet Engineering Task Force) Request for Comments (RFC) 2002 specification called “IP Mobility Support”, which is herein included by reference in its entirety.

The AAA server of a CDMA2000 network intelligently controls access to network resources, enforces policies, audits the usage, and provides the information necessary to bill for the services accessed by the MNs. These combined processes are essential for effective network management and security. Typically, the MA server gathers accounting information as received by the network entities based on the number of data packets exchanged by the mobile node with the network, or duration of the data session. For this purpose, the AM server typically receives accounting messages from the PDSN involved in the data session for the given mobile node. In current CDMA2000 implementations, the PDSN generates accounting by counting the IP packets/octets associated with the IP address assigned to the mobile node, or metering the duration of the data session, before sending the accounting messages to the AAA server. The serving PDSN connects to the MN typically via a Point-to-Point Protocol (PPP) connection.

In CDMA2000 IP-based cellular telecommunications networks, a service option is a service capability of the system. Service options represents services such as voice, data, facsimile, etc, which can be supported over a given connection. A service option connection, also called herein a service instance or session, is a connection in which the service defined by a service option is used.

In order to provide better quality of service for packet-demanding applications, certain service options supported in CDMA2000 networks allow for voice communications with header-removed (service option SO60) or header-compressed (service option SO61) IP/UDP/RTP packets between the base station and the MN. The base station connects the service option to a PCF and from there to the serving PDSN, where header compression or header removal takes place. These service options are typically designed for the transport of voice application data between the MN and a correspondent node on the IP network, and they each require the use of an associated packet data service instance connected to the same PDSN. These service instances dedicated to the support of specific service options (e.g. live video teleconference) are called auxiliary service instances and are established between the MN and the serving PDSN on top of the main service instance for a PPP connection. Typically, depending upon the application, a PPP connection can support up to one main service instance and 6 auxiliary service instances.

For example, service option 60 “so60” supports a header removal service. Header removal is a technique used to support mobile terminals that require transport of encoded speech directly from the multiplex sublayer to the speech encoder/decoder. Speech frames are transported in a similar fashion as the existing circuit switched application, while the connected service is a Voice-over-IP (VoIP) service. Service option 61 “so61” supports a header compression service. Header compression is a technique used to transparently compress and decompress the header fields of a packet on a per-hop basis. The RObust Header Compression (ROHC) framework was developed to improve efficiency over bottleneck links and over low bandwidth wireless links with high error rates. Thus, in CDMA2000, the variable rate VoIP service option that provides a header removal service is assigned the service option number 60 and is called service option 60, while the variable rate VoIP service option that provides header compression service is assigned service option number 61 and is called service option 61.

Reference is now made to FIG. 1 (Prior Art) that shows a high-level block diagram of a typical CDMA2000 IP-based cellular telecommunications network 100. In the CDMA2000 network 100, prepaid service allows an end-user's MN 101 to purchase packet data service in advance based on volume or service duration. The prepaid account status is stored in a PrePaid Server (PPS) 102 that is located in the end-user's home network 104 and accessed via a Home Authorization, Authentication & Accounting (HAAA) server 106. A Prepaid Client 108 residing in an HA 109 communicates with the PPS 102 via the HAAA server 106. The function of the HA's Prepaid Client 108 is to perform on-line accounting of the Mobile IP session (i.e.: to allow the Mobile IP traffic according to the granted volume or duration, and to block the Mobile IP traffic if not granted). To provide service to roaming prepaid end-users, a serving PDSN 110 also needs to support a Prepaid Client 111 for performing on-line accounting of the IP session. Accounting messages from the serving PDSN 110 may be sent to the Home AM server 106 via a Visited AAA server 116, which serves as proxy. The HAAA 106 and the Prepaid server 102 can be either collocated, in which case the collocated functionality is herein called an HAAA/PPS server 112 and is shown in dotted lines, or could be separate entities. From the serving PDSN 110 or the HA 109 perspective, the HAM 106 and the PPS 102 are indistinguishable, and thus will be herein referred to as an HAAA/PPS server.

When a prepaid user's MN 101 performs Simple IP with authentication or Mobile IP access, the MN first requests the establishment of a Point-to-Point Protocol (PPP) connection over the main service instance, which is the default service instance between the MN and the PDSN 110. For this purpose, the PDSN 110 sends a RADIUS (Remote Authentication Dial In User Service) Access-Request message (not shown) to the HAAA/PPS server 112 for authentication and authorization, the former performs authentication and authorization for the prepaid user, and notifies back the PDSN 110 of the successful outcome via a RADIUS Access Accept message. Following the user's authorization and authentication, the PDSN 110 relays the registration request message received from the prepaid user to the HA 109, which sends an Access Request message to the HMA/PPS server 112 to demand establishment of a prepaid duration-based or volume-based quota. The HAAA/PPS server 112 checks the existing prepaid balance for the user account, and authorizes prepaid services. It finally returns an interim prepaid quota (duration-based or volume-based) to the PDSN 110 via the HA 109. At this point, the Point-to-Point Protocol (PPP) connection over the main service instance is established between the PDSN 100 and the prepaid user's MN 101 for the duration, or data volume, specified by the interim prepaid quota.

The present prior art implementation presents a significant drawback associated with the lost of data packets sent by real-time applications from a prepaid MN over an auxiliary service instance. For example, once a prepaid MN establishes the PPP connection over the main service instance, the MS may request an auxiliary service instance to carry real time application such as a voice or videoconference application. The PDSN authorizes the establishment of the auxiliary service instance based on the user service option profile received from the user's home network during PPP establishment over the main service instance. When the request for the auxiliary service instance is received by the PDSN, and it is allowed based on the prepaid user's profile, the PDSN requests from HAAA/PPS a prepaid quota for that service option. Until the PDSN receives a quota from the home prepaid system, the prepaid user's traffic is blocked at the PDSN. Therefore, the present prior art approach for installing a prepaid quota relative to the auxiliary service instances engenders non-negligible time delays during which the real-time applications' data packets send by the prepaid user are simply discarded by the PDSN. The present situation results in the lost of valuable legitimate data and thus engenders a loss of service for the customer as well as a loss of revenues for the operator.

There is therefore a need for a solution that minimizes the lost of data packets associated with the setup of a prepaid data session with multiple service instances. The present invention provides such a solution.

### SUMMARY OF THE INVENTION

It is an object of the present invention to provide a method for setting up a prepaid quota for a prepaid subscriber in a Packet Data Access Node (PDAN), the method comprising the steps of:

a. receiving by the PDAN an indication from a Home Authorization, Authentication, and Accounting Prepaid Server functionality (HAAA/PPS) that a connection with the prepaid subscriber can support at least one auxiliary service instance;

b. responsive to the receipt of the indication, requesting by the PDAN from the HAAA/PPS a prepaid quota relative to the at least one auxiliary service instance; and

c. receiving by the PDAN the prepaid quota from the HAAA/PPS; and

d. pre-installing the prepaid quota for the at least one auxiliary service instance in the PDAN.

It is another object of the present invention to provide a Packet Data Access Node (PDAN) acting to receive from a Home Authorization, Authentication, and Accounting Prepaid Server functionality (HAAA/PPS) an indication that a connection with a prepaid subscriber can support at least one auxiliary service instance and responsive to the receipt of the indication, acting to request from the HAAA/PPS a prepaid quota relative to the at least one service instance, and when receiving the prepaid quota from the HAAA/PPS, acting to pre-install the prepaid quota for the at least one auxiliary service instance relative to the prepaid subscriber.

It is another object of the present invention to provide a packet data system comprising:

a prepaid terminal;

a Packet Data Access Node (PDAN) serving the prepaid terminal;

a Home Authorization, Authentication, and Accounting Prepaid Server functionality (HAAA/PPS) storing a prepaid subscription and a profile of the prepaid terminal;

wherein when the PDAN receives an indication from the HAAA/PPS that a connection with the prepaid subscriber can support at least one auxiliary service instances, the PDAN requests from the HAAA/PPS a prepaid quota relative to the at least one auxiliary service instance, and when the PDAN receives the prepaid quota from the HAAA/PPS, the PDAN pre-installs the prepaid quota for the at least one auxiliary service instance.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a schematic network diagram of an existing Code Division is Multiple Access (CDMA) 2000 IP-based cellular telecommunications network; and

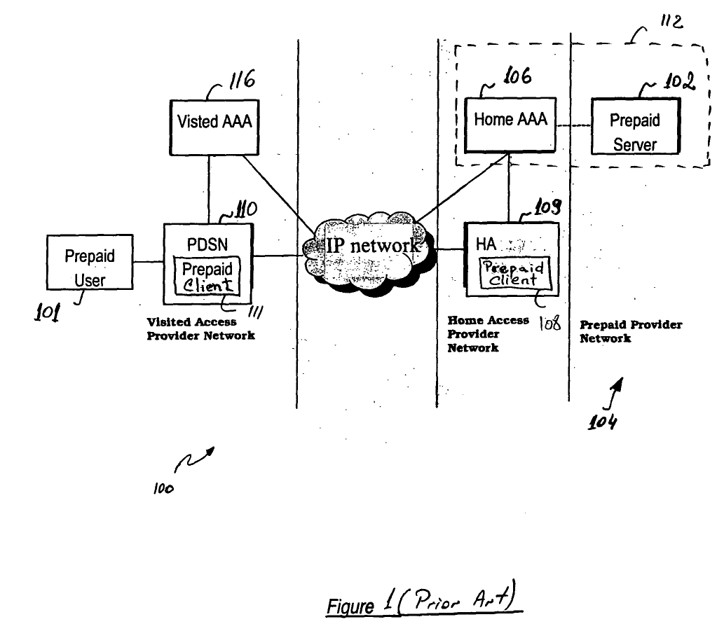

FIG. 2 is an exemplary nodal operation and signal flow diagram of a CDMA 2000 IP-based cellular telecommunications network implementing a prepaid service authorization access according to the preferred embodiment of the present invention.

### DETAILED DESCRIPTION OF THE PREFERRED EMBODIMENTS

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

The present invention allows a prepaid terminal, such as for example a prepaid MN, to be pre-allocated a prepaid quota for one or more auxiliary service instances if the MN's subscription profile indicates that the MN is allowed to setup certain types of service options, such as for example but not limited to service option 60 “so60”, service option 61 “so61”, or others. The present invention can be useful especially, but not limited to, situations wherein the requested service options are related to packet-demanding real-time applications, such as for example, voice over IP, video teleconferencing, etc. The quota pre-allocation of the present invention prevents a Packet Data Access Node (PDAN), such as a PDSN of a CDMA2000 system, from blocking or discarding data traffic at the time the MN establishes service instances with such service option. This is critical for real-time applications such as voice over IP or push to talk, as blocking data packets can have a noticeable damaging effect to the user's communication since, for example, losing data packets results in the loss of talk bursts during a voice conversation.

In order to achieve this scope, the present invention allows for a pre-initialization (also called herein a pre-installation or pre-allocation) of a prepaid quota in the serving PDSN when certain particular service options are allowed by the subscription profile received from the authorization infrastructure (e.g. the HAAA/PPS). The subscription profile indicative of the possibility to establish multiple service instances is received by the serving PDSN when the MN first successfully establishes the PPP connection over the main service instance with the PDSN. The PDSN determines if the allowed service options from the subscription profile have real time characteristics, such as for example comprising the service option 60 “so60” or the service option 61 “so61 ” and if so, the PDSN immediately requests pre-initialization of a quota from the prepaid server before even the MS has explicitly requested establishment for such service options. Then, when the prepaid MN desires to establish a live videoconference, a voice session, or any other type of live or broadband transmission with another user, the MN requests the establishment of one or more auxiliary service instances, as allowed by his subscription profile, with a particular associated service option, such as for example with service option “so61”. According to the present invention, in this situation the prepaid user is immediately allowed to exchange data packets over that auxiliary connection at the moment it is established, since a prepaid quota has already been pre-allocated for that service option.

It is to be noted that although the preferred embodiment of the present invention is be described herein with exemplary reference being made to an exemplary is CDMA2000 network comprising a prepaid mobile node and a PDSN, the present invention is not limited thereto, but can be advantageously implemented with any kind of prepaid terminal and PDAN.

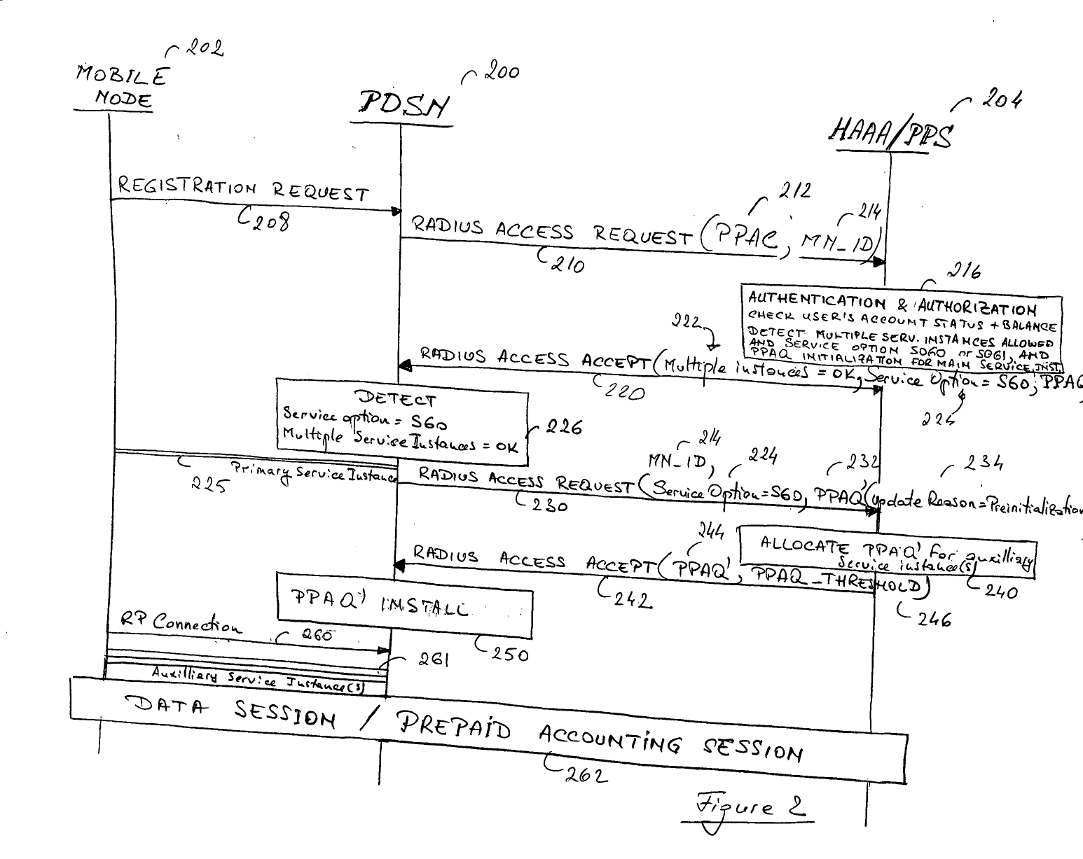

Reference is now made to FIG. 2, which is an exemplary nodal operation and signal flow diagram of a CDMA 2000 IP-based cellular telecommunications network implementing a prepaid service authorization access according to the preferred embodiment of the present invention. Shown in FIG. 2 is a serving PDSN 200 that serves a prepaid user's MN 202, and an HAAA/PPS server 204 as described hereinbefore (note that the HAAA/PPS may alternatively be an HAAA server). The serving PDSN 200 receives a Mobile IP or Simple IP Registration Request (RRQ) 208 from the prepaid MN 202, and responsive to the request 208, issues a RADIUS Access Request message 210 to the HAAA/PPS 204, the message 210 comprising i) a PrePaidAccountingCapability (PPAC) parameter 212 indicative of the fact the PDSN is capable of supporting prepaid service and ii) the identity 214 of the MN 202. In action 216, the HAAA/PPS 204 performs authentication and authorization of the prepaid MN 202, which may include one or more actions as follows: verifying that the subscriber profile indicates prepaid subscription, an initialization and allocation g a Prepaid Accounting Quota (PPAQ) for the main service instance, determining if the user's profile indicates the possible use of multiple service instances, determining if the user profile indicates prepaid subscription to certain particular service options such as for example service option 60 “so60” or service option “so61”, or other real time service options, checking the user's account balance, checking if the prepaid capability PPAC 212 is sent by the serving PDSN 200 (in this exemplary scenario it is), and checking the home network policy.

Once the MN 202 is authenticated and authorized in action 216, the HAAA/PPS 204 returns to the serving PDSN 200 a RADIUS Access Accept message 220 with an indication 222 that the MN 202 has a prepaid subscription to multiple instances, with a second indication 224 that one of the subscribed services relates to a particular service option, such as for example “so60/61”, and with the PPAQ 225 for the main service instance. In action 226, the PDSN 200 receives the message 220 and detects that the MN 202 has a subscription to multiple service instances and that a particular service option of real time characteristics is allowed. Following action 220, the PDSN 200 establishes the primary service instance 225 with the MN 202. Responsive to the detection of action 226, the serving PDSN 200 also immediately requests a pre-initialization of a PPAQ′ for the auxiliary service instance(s) by sending a RADIUS Access Request message 230 to the HAAA/PPS 204 in order to request pre-initialization of an interim prepaid quota for the auxiliary service instances the MN 202 may establish. The message 230 may comprise the MN identity 214, the indication 224 that the particular service option is allowed, and a PPAQ′ Update parameter 232 with an update reason indicator 234 indicating pre-initialization of a quota. This message requests from the HAAA/PPS 204 a pre-allocation of a prepaid quota for the auxiliary service instances of the MN 202. In action 240, the HAAA/PPS 204 proceeds to the initialization and allocation of an interim PPAQ′ for the auxiliary service instances, which may be preferably a duration-based quota, and returns in action 242 via a RADIUS Access Accept message the allocated interim PPAQ′ 244 and an allocated threshold quota 246 (to be used by the serving PDSN 200 for triggering another, subsequent interim message toward the HAAA/PPS). In action 250, the serving PDSN 200 pre-installs the newly received prepaid interim quota PPAQ′ 244, so that data packets originated by the MN 202 at the time the service option is established can be successfully routed without any blocking done by the PDSN. In case the MN 202 does not establish the service option for which the prepaid quota has been pre-initialized, the PDSN 200 may report back the PPAQ′ 244 to the HAAA/PPS 204 when the PPP session is terminated (actions not shown).

In action 260, the MN 202 requests the establishment of an RP data session over the established PPP connection for carrying on the desired service such as for example a live videoconferencing service. Thus, one or more auxiliary service instances 261 associated with the requested service option, for example “so60” or “so61” are established between the MN 202 and the PDSN 200, and data packets originated by the MN 202 start reaching the PDSN 200. With the present invention, once the data packets of the MN 202 reach the PDSN 200 over the auxiliary service instances, the PDSN 200 immediately properly routes the packets, since a prepaid quota PPAQ′ 244 is already installed in the PDSN for these service instances.

The RP data session is continued in action 262, and the prepaid accounting session is performed with the periodic transmission of accounting interim messages between the serving PDSN 200 and the HAAA/PPS server 204, until its completion.

Based upon the foregoing, it should now be apparent to those of ordinary skill in the art that the present invention offers an advantageous solution, which allows for a more suitable provision of a prepaid quota for auxiliary service instances in the PDSN. Although the system and method of the present invention have been described in particular reference to certain exemplary actions for carrying out the invented concept, it should be realized upon reference hereto that the innovative teachings contained herein are not necessarily limited thereto, and may be implemented advantageously using different approaches. For example, although the exemplary preferred embodiment of the invention has been described with reference being primarily made to the HAAA/PPS, it is understood that a standalone HAAA or a PPS, or any other type of equivalent node, herein designated by the generic term HAAA/PPS, can be used for carrying out the invention.

Furthermore, the present invention is not limited to an allocation of an initial prepaid quota for service options “so60” or “so61”, which are herein provided as non-limitative examples only, but can be generalized as applicable to any service options that would require a pre-allocation of a quota. Furthermore, the present invention is applicable to any service option that carries real time traffic, and is also not limited to CDMA2000 systems, but can rather be implemented to any kind of access technology having multiple connections (service instances). Finally, although reference was made throughout the present description to a HAAA/PPS, it is understood that its function can be alternatively performed by an HAAA server alone, a PPS server alone, or any other combination of functionality capable of storing a subscriber profile, herein referred to as the HAAA/PPS.

It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for setting up a prepaid quota for a prepaid subscriber in a Packet Data Access Node (PDAN), the method comprising the steps of:
a. receiving by the PDAN an indication from a Home Authorization, Authentication, and Accounting Prepaid Server functionality (HAAA/PPS) that a connection with the prepaid subscriber can support at least one auxiliary service instance;
b. responsive to the receipt of the indication, requesting by the PDAN from the HAAA/PPS a prepaid quota relative to the at least one auxiliary service instance;
c. receiving by the PDAN the prepaid quota from the HMA/PPS; and
d. pre-installing the prepaid quota for the at least one auxiliary service instance in the PDAN.

2. The method of claim 1, wherein the method is performed responsive to a Registration request message sent from the prepaid subscriber to the PDAN.

3. The method of claim 1, wherein the indication also specifies that a profile of the prepaid subscriber includes a subscription to one or more particular service options.

4. The method claimed in claim 3, wherein the PDAN is a CDMA2000 Packet Data Service Node (PDSN) and the prepaid subscriber is a CDMA2000 subscriber.

5. The method claimed in claim 4, wherein the one or more service options includes service option 60.

6. The method claimed in claim 4, wherein the one or more service options includes service option 61.

7. The method of claim 4, wherein the PDSN receives the indication in a RADIUS Access Accept message sent by the HAAA/PPS.

8. A Packet Data Access Node (PDAN) acting to receive from a Home Authorization, Authentication, and Accounting Prepaid Server functionality (HAAA/PPS) an indication that a connection with a prepaid subscriber can support at least one auxiliary service instance and responsive to the receipt of the indication, acting to request from the HAAA/PPS a prepaid quota relative to the at least one service instance, and when receiving the prepaid quota from the HAAA/PPS, acting to preinstall the prepaid quota for the at least one auxiliary service instance relative to the prepaid subscriber.

9. The PDAN of claim 8, wherein the PDAN receives a Registration request message from the prepaid subscriber, and signals the HAAA/PPS for authenticating and authorizing the prepaid subscriber prior to receiving the indication.

10. The PDAN of claim 8, wherein the indication also specifies that a profile of the prepaid subscriber includes a subscription to one or more particular service options.

11. The PDAN claimed in claim 10, wherein the PDAN is a CDMA2000 Packet Data Service Node (PDSN) and the prepaid subscriber is a CDMA2000 subscriber.

12. The PDSN claimed in claim 11, wherein the one or more service options includes service option 60.

13. The PDSN claimed in claim 11, wherein the one or more service options includes service option 61.

14. The PDSN of claim 11, wherein the PDSN receives the indication in a RADIUS Access Accept message sent by the HAAA/PPS.

15. A packet data system comprising:
a prepaid terminal;
a Packet Data Access Node (PDAN) serving the prepaid terminal; and
a Home Authorization, Authentication, and Accounting Prepaid Server functionality (HAAA/PPS) storing a prepaid subscription and a profile of the prepaid terminal;
wherein when the PDAN receives an indication from the HAAA/PPS that a connection with the prepaid subscriber can support at least one auxiliary service instance, the PDAN requests from the HAAA/PPS a prepaid quota relative to the at least one auxiliary service instance, and when the PDAN receives the prepaid quota from the HAAA/PPS, the PDAN pre-installs the prepaid quota for the at least one auxiliary service instance.

16. The packet data system of claim 15, wherein the prepaid terminal first sends a Registration request message to the PDAN.

17. The packet data system of claim 15, wherein the indication also specifies that the profile of the prepaid subscriber includes a subscription one or more particular service options.

18. The packet data system claimed in claim 17, wherein the PDAN is a CDMA2000 Packet Data Service Node (PDSN) and the prepaid subscriber is a CDMA2000 subscriber.

19. The packet data system claimed in claim 18, wherein the one or more service options include service option 60.

20. The packet data system claimed in claim 18, wherein the one or more service options include service option 61.

21. The packet data system of claim 18, wherein the PDSN receives the indication in a RADIUS Access Accept message sent by the HAAA/PPS.
